(19) United States
(12) Patent Application Publication
(10) Pub. No.: US 2026/0161911 A1
(43) Pub. Date: Jun. 11, 2026

(54) PRINT CONTROL APPARATUS, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventors: Shieka Arai, Tokyo (JP); Kota Terayama, Kanagawa (JP)

(21) Appl. No.: 19/392,204

(22) Filed: Nov. 18, 2025

(30) Foreign Application Priority Data
Dec. 10, 2024 (JP) 2024-215396

(51) Int. Cl. G06K 15/02; G07C 15/00

(52) U.S. Cl. CPC G06K 15/1807; G06K 15/1886; G07C 15/006

(57) ABSTRACT

A print control apparatus that can easily set a lottery probability in random printing by using rating information of image data. The print control apparatus is capable of controlling to perform random printing to print image data randomly selected from a plurality of image data stored in a storage area. The print control apparatus includes a memory device that stores a set of instructions, and at least one processor that executes the set of instructions to set lottery probabilities of the image data for respective rating information assigned to the image data, select image data as a print target of the random printing by performing a lottery from among the plurality of image data based on the rating information assigned to the image data and the lottery probabilities set to the image data, and control a printer to print the image data selected by the lottery.

### BACKGROUND

### Field of the Technology

The aspect of the embodiments relates to a print control apparatus, a control method therefor, and a storage medium storing a control program therefor.

### Description of the Related Art

There is an increasing demand for a random printing service to print a digital content, such as image data, randomly selected from a plurality of contents.

For example, Japanese Patent Laid-Open No. 2006-313990 (JP 2006-313990A) discloses a system constructed by a server that stores a plurality of image data, a printer, and a PC that instructs the server to transmit image data held by a lottery from the plurality of image data to the printer. In the random printing by such a system, an operator cannot predict which of the plurality of image data is printed, and therefore, the operator feels more pleasure when an expected image data is obtained, and an entertainment property is enhanced.

Further, Japanese Patent Laid-Open No. 2002-103704 (JP 2002-103704A) discloses a printer that is capable of omitting time and effort in setting a decoration for every print instruction by sequentially printing a plurality of types of decoration image data at random in accordance with a print instruction from a user, printing quickly and easily, and having an entertainment property.

In order to further enhance the entertainment property of the random printing, it is important to easily set a lottery probability, for example, to make a rare content more difficult to win than other contents in addition to keep an amount and quality of image data. However, in the above-described conventional techniques, the lottery probability is uniform. That is, in the conventional random printing, it is not possible to easily set the lottery probability, for example, to make a rare content more difficult to win than other contents.

### SUMMARY

The present disclosure provides a mechanism that can easily set the lottery probability in random printing by using rating information of image data.

Accordingly, an aspect of the embodiments provides a print control apparatus capable of controlling to perform random printing to print image data randomly selected from a plurality of image data stored in a storage area, the print control apparatus including a memory device that stores a set of instructions, and at least one processor that executes the set of instructions to set lottery probabilities of the image data for respective rating information assigned to the image data, select image data as a print target of the random printing by performing a lottery from among the plurality of image data based on the rating information assigned to the image data and the lottery probabilities set to the image data, and control a printer to print the image data selected by the lottery.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram showing an internal configuration of a printer as a print control apparatus according to an embodiment.

FIG. 2A and FIG. 2B are external views showing the printer in FIG. 1.

FIG. 3 is a view schematically illustrating processing modules included in the printer in FIG. 1.

FIG. 4 is a flowchart illustrating a procedure of a random print control process executed by the printer in FIG. 1.

FIG. 5A to FIG. 5C are views for describing data stored in a storage medium in FIG. 1.

FIG. 6A to FIG. 6E are views illustrating examples of screens displayed on a display unit in FIG. 1.

FIG. 7 is a flowchart illustrating a procedure of a probability calculation process in S412 in FIG. 4.

FIG. 8A to FIG. 8C are view showing setting examples of association of decoration data to be synthesized with selected image data.

FIG. 9A and FIG. 9B are views illustrating examples of configurations of image data used in the present embodiment.

FIG. 10 is a flowchart illustrating a procedure of a random print control process executed by a printer in a second embodiment.

### DESCRIPTION OF THE EMBODIMENTS

Hereinafter, preferred embodiments of the present disclosure will be described in detail with reference to the accompanying drawings.

First, a print control apparatus and a control method thereof according to the first embodiment of the present disclosure will be described.

In the first embodiment, a lottery probability in random printing is set on the basis of rating information assigned to image data. Therefore, when rating information is given to image data captured and stored in a storage medium by a camera, it is possible to perform the random printing with a simple configuration constituting only a camera and a printer by inserting the storage medium into the printer as a print control device of the present embodiment and activating and executing the printer in a random print mode. The rating information may be assigned when the image data is organized by a PC after the capturing by the camera. In this case, a PC is required, but an assignment operation using the PC is easier than that using the camera in viewpoints of editing efficiency and perspicuity of the rating information.

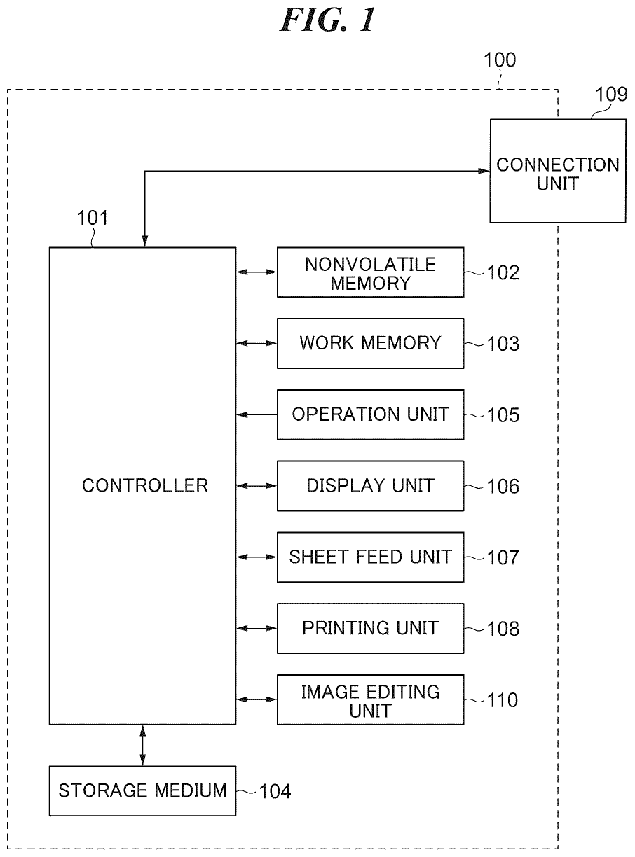

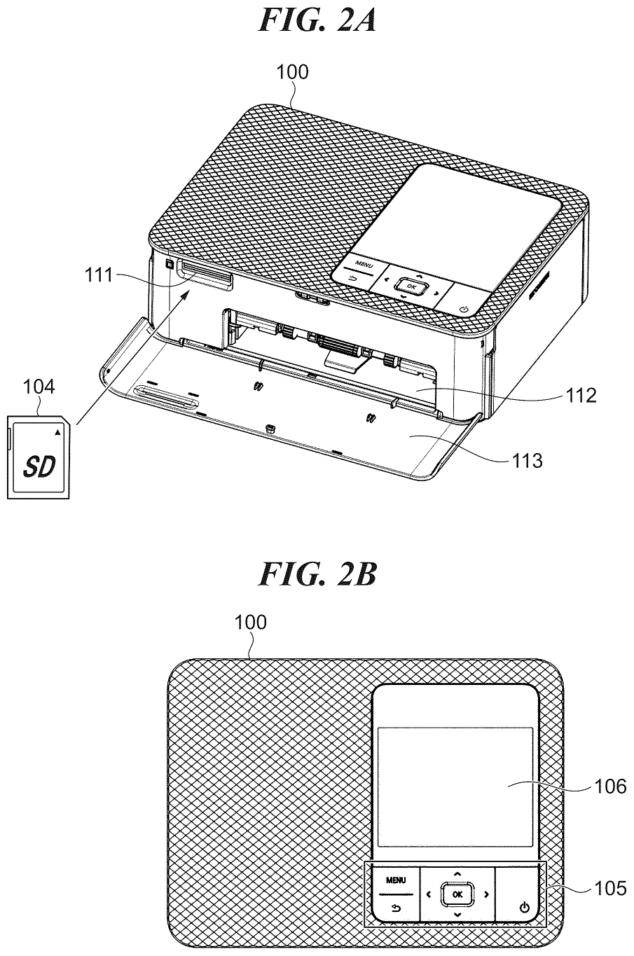

Outlines of a configuration, a function, and an operation of the print control apparatus according to the embodiment of the present disclosure will be described with reference to FIG. 1, FIG. 2A, and FIG. 2B.

FIG. 1 is a block diagram showing an internal configuration of the printer 100 as the print control apparatus according to the embodiment. FIG. 2A and FIG. 2B are external views showing the printer 100 in FIG. 1. FIG. 2A is an external perspective view of the printer 100, and FIG. 2B is an external plan view of the printer 100 viewed from an upper surface side thereof.

As shown in FIG. 1, the printer 100 includes a controller 101, a nonvolatile memory 102, a work memory 103, a storage medium 104, an operation unit 105, a display unit 106, a sheet feed unit 107, a printing unit 108, a connection unit 109, and an image editing unit 110. The controller 101 is connected to the nonvolatile memory 102, the work memory 103, the storage medium 104, the operation unit 105, the display unit 106, the sheet feed unit 107, the printing unit 108, the connection unit 109, and the image editing unit 110.

The controller 101 controls each unit of the printer 100 according to an input signal or a program described later. Instead of the controller 101 controlling the entire apparatus, a plurality of hardware components may share the process to control the entire printer 100.

The nonvolatile memory 102 is an electrically erasable and programable nonvolatile memory, and stores programs described later executed by the controller 101.

The work memory 103 is used as a work area for the controller 101 to execute a process, an image display memory of the display unit 106, and a buffer memory for temporarily storing image data received from the connection unit 109.

The storage medium 104 can store image data and the like. The storage medium 104 may be configured to be attachable to and detachable from the printer 100 or may be built in the printer 100. That is, the printer 100 may have at least a unit for accessing the storage medium 104.

The operation unit 105 is used to receive an instruction of a user to the printer 100. The operation unit 105 includes, for example, operation members, such as a power button to instruct ON/OFF of the power of the printer 100, a print start button to instruct printing, and left and right buttons to instruct image feeding in reproducing image data. A touch panel formed in the display unit 106 described later is also included in the operation unit 105.

The display unit 106 displays image data, characters for interactive operation screen, and the like. The display unit 106 is not necessarily built in the printer 100. The printer 100 may be connected to the internal or external display unit 106 and may have at least a display control function of controlling the display of the display unit 106.

The sheet feed unit 107 stores recording sheets and conveys a recording sheets to the printing unit 108 described later. The sheet feed unit 107 may be provided with a sensor or a switch to obtain the size of the stored recording sheets. Alternatively, the sheet feed unit 107 may store a plurality of sizes of recording sheets. The recording sheet is not limited to a paper sheet, and may be a sheet of material other than paper.

The printing unit 108 performs printing on the recording sheet conveyed from the sheet feed unit 107. The connection unit 109 is an interface to connect with an external apparatus. The printer 100 of the present embodiment can exchange data with an external apparatus via the connection unit 109. In the present embodiment, the connection unit 109 includes an interface to communicate with an external apparatus via a wireless LAN. The controller 101 achieves wireless communication with an external apparatus by controlling the connection unit 109. The communication method is not limited to the wireless LAN.

The image editing unit 110 reads the image data stored in the work memory 103, and converts the image format, for example from a JPEG format to a YMC format, and performs encryption and decryption using a known encryption algorithm. In addition, the image editing unit 110 synthesizes image data and decoration data. The decoration data is data, such as frame image data, to decorate image data. The file format of image data may be a JPEG file, a GIF file, a PNG file, a BMP file, or the like, but is not limited thereto.

Next, the appearance of the printer 100 will be described. As shown in FIG. 2B, the operation unit 105 that is constituted by the power button, a cross key, a MENU button, a cancel button, and the like, and the display unit 106 that are provided on the upper surface of the printer 100. As shown in FIG. 2A, a card slot 111 to insert the storage medium 104 such as an SD card and an attachment port 112 of a sheet feed/discharge tray that are provided on the front surface of the printer 100 can be covered with an open/close cover 113.

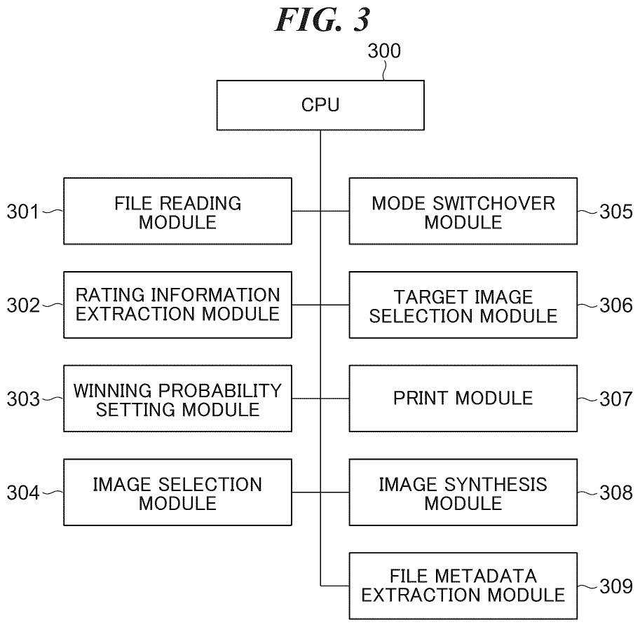

FIG. 3 is a view schematically illustrating processing modules included in the printer 100 in FIG. 1.

The various processing modules illustrated in FIG. 3 are, for example, software modules. The various processing modules illustrated in FIG. 3 are achieved by the CPU 300 included in the controller 101 developing a predetermined program stored in the nonvolatile memory 102 onto the work memory 103 and executing the program so that the respective modules included in the printer 100 performs the predetermined operations based on commands from the CPU 300. The various processing modules shown in FIG. 3 are not limited to software modules, and the printer 100 may include hardware modules that achieves the functions of these processing modules.

The printer 100 includes a file reading module 301, a rating information extraction module 302, a lottery probability setting module 303, an image selection module 304, a mode switchover module 305, and a target image selection module 306. The printer 100 further includes a print module 307, an image synthesis module 308, and a file metadata extraction module 309.

The mode switchover module 305 switches the mode of the printer 100 between a normal print mode to perform normal printing and a random print mode to performing random printing. In the random print mode, the file reading module 301 reads the image data recorded in the storage medium 104 inserted into the card slot 111, and the rating information extraction unit 302 extracts the rating information from the file metadata of the read image data. The configuration of the file metadata will be described later. The target image selection module 306 makes a user select a folder storing image data to be a lottery target in the random printing, and the lottery probability setting module 303 calculates the lottery probability of image data in the random printing by a predetermined method. When the user performs the start operation of the random printing, the image selection module 304 performs a lottery according to the calculated lottery probability to select the image data, and the print module 307 prints the selected image data.

When the decoration data is synthesized in the random printing, the printer 100 performs the same process on the decoration data in addition to the process on the image data described above. Specifically, the file metadata extraction module 309 extracts rank information from the file metadata information of the decoration data read by the file reading module 301. The target image selection module 306 makes the user select a folder storing decoration data to be a lottery target in the random printing, and the lottery probability setting module 303 calculates the lottery probability of the decoration data in the random printing by a predetermined method. In the random printing, the image selection module 304 selects the image data and the decoration data by performing a lottery according to the calculated lottery probabilities. The image synthesis module 308 synthesizes the selected image data and the decoration data to generate synthesized image data, and the print module 307 prints the synthesized image data.

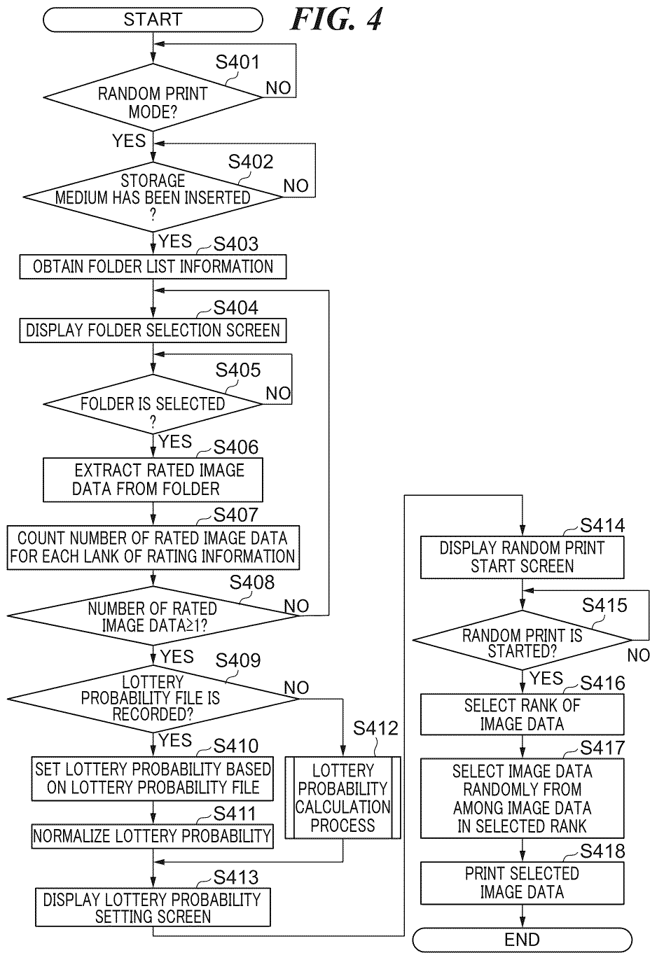

Next, the random print mode in the present embodiment will be described. When the mode of the printer 100 is switched to the random print mode, the controller 101 randomly selects image data from a plurality of image data recorded in the storage medium 104 and performs a print process of the selected image data. The print operation in the random print mode will be described using FIG. 4 to FIG. 6E.

FIG. 4 is a flowchart illustrating a procedure of a random print control process executed by the printer 100 in FIG. 1. The random print control process is achieved by the controller 101 controlling each unit of the printer 100 according to an input signal and a program. The random print control process is started together with the activation of the printer 100 in response to reception of an instruction to start the random print mode by an activation operation by a user.

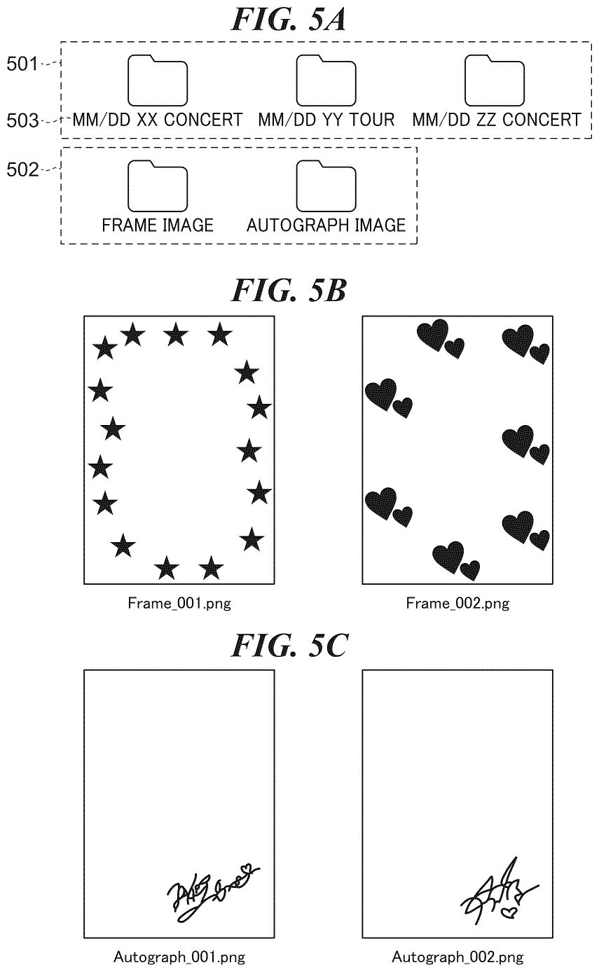

Here, data stored in the storage medium 104 will be described with reference to FIG. 5A to FIG. 5C. FIG. 5A illustrates a folder configuration stored in the storage medium 104. A folder group 501 shown in an upper row stores image data, and a folder group 502 shown in a lower row stores decoration data. In the present embodiment, a folder to be a lottery target is selected from each of the folder group 501 and the folder group 502. A name of a content of an event indicating what kind of image data is stored in each folder is set as a folder name 503. FIG. 5B shows examples of decoration data stored in a folder named “FRAME IMAGE” in the lower folder group 502. FIG. 5C shows examples of decoration data in an autograph format stored in a folder named “AUTOGRAPH IMAGE” in the lower folder group 502. The image editing unit 110 may randomly decide whether image data is synthesized with decoration data as with the selection of image data. There are a plurality types of decoration data, such as a decoration that has a transparent plain part and is superimposed on image data, and a decoration that is pattern-decorated on an overcoat of a protective layer.

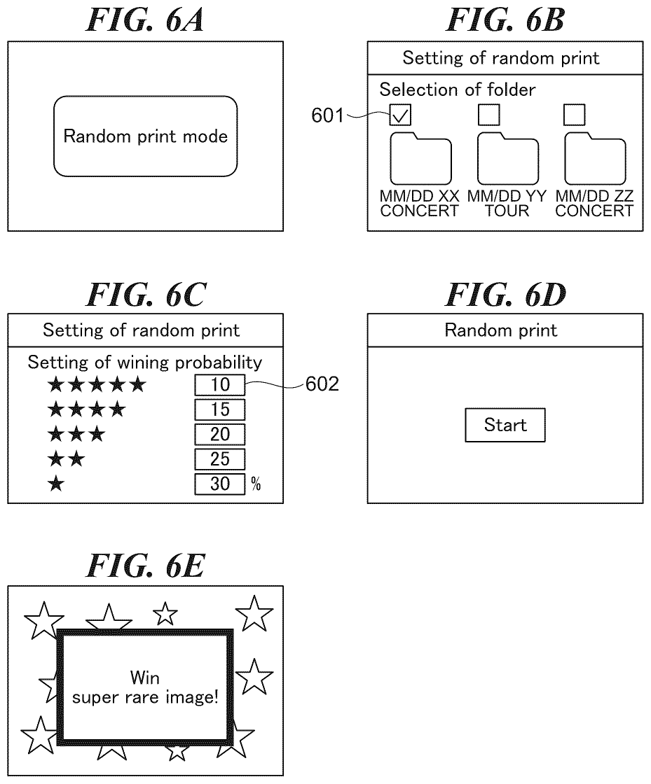

In FIG. 4, first, the controller 101 determines whether the mode activated by a user operation is the random print mode in S401. When the mode activated by the user operation is determined not to be the random print mode, the process returns to S401. When the mode activated by the user operation is determined as the random print mode, the controller 101 notifies the user that it is not the normal print mode but the random print mode. Specifically, the controller 101 controls the mode switchover module 305 to display a screen shown in FIG. 6A indicating the random print mode on the display unit 106. Then, the process proceeds to S402.

In S402, the controller 101 determines whether the storage medium 104 has been inserted into the card slot 111. When it is determined that the storage medium 104 has not been inserted into the card slot 111, the process returns to S402. When it is determined that the storage medium 104 has been inserted into the card slot 111, the process proceeds to S403.

In S403, the controller 101 controls the file reading module 301 to obtain list information of folders (storage areas) stored in the storage medium 104.

Next, in S404, the controller 101 controls the target image selection module 306 to display a folder selection screen shown in FIG. 6B on the display unit 106 based on the list information obtained in S403. The folder selection screen shows folders described in the list information obtained in S403. This allows a service provider to confirm the folder configuration in the storage medium 104 illustrated in FIG. 5A. In addition, it is possible to select a lottery target folder in the random printing on the folder selection screen. Accordingly, the service provider can set the image data to be printed in the random printing according to the content of the event by checking check boxes 601 on the folder selection screen.

Next, in S405, the controller 101 determines whether a lottery target folder in the random printing is selected on the folder selection screen. When it is determined that the lottery target folder in the random printing is not selected, the process returns to S405. When it is determined that the lottery target folder in the random printing is selected, the process proceeds to S406. In the present embodiment, one folder shall be selected from the folder group 501 storing image data as the lottery target folder in the random printing.

In S406, the controller 101 controls the rating information extraction module 302 to extract image data to which rating information indicating a rank of 1 or more is given (hereinafter referred to as “rated image data”) from the folder selected in S405. Next, in S407, the controller 101 controls the rating information extraction module 302 to count the number of image data for each rank indicated by the rating information.

Next, in S408, the controller 101 determines whether the number of rated image data is one or more. When it is determined that the number of the rated image data is less than one, the process returns to S404, and the service provider is allowed to set another folder recorded in the storage medium 104. When it is determined that the number of the rated image data is one or more, the process proceeds to S409.

In S409, the controller 101 controls the file reading module 301 to determine whether a lottery probability file is recorded in the storage medium 104. The lottery probability file includes, for example, lottery probability information that differs for each rank. When it is determined that the lottery probability file is recorded in the storage medium 104, the process proceeds to S410. When it is determined that the lottery probability file is not recorded in the storage medium 104, the process proceeds to S412 described later.

In S410, the controller 101 controls the lottery probability setting module 303 to set the lottery probability of image data based on the lottery probability file read from the storage medium 104.

Next, in S411, the controller 101 controls the lottery probability setting module 303 to normalize the lottery probabilities set for the respective ranks so that the sum of the lottery probabilities becomes 100%. Specifically, the lottery probability of each rank is divided by a value obtained by subtracting a probability of a rank in which no image data is included from 100, and the divided value is multiplied by 100. Here is assumed that the lottery probability file includes information indicating that a lottery probability in a rank 1 is 30%, a lottery probability in a rank 2 is 25%, a lottery probability in a rank 3 is 20%, a lottery probability in a rank 4 is 15%, and a lottery probability in a rank 5 is 10%. Further, a case where the folder selected in S405 includes no image data in the rank 1 will be described as an example. In such a case, the normalized lottery probabilities in the second to rank 5s are calculated as follows.

$$Normalized lottery probability in rank 2 : \{ 25 / ( 100 - 30 ) \} \cdot 100 = 35.7 \%$$

$$Normalized lottery probability in rank 3 : \{ 20 / ( 100 - 30 ) \} \cdot 100 = 28.6 \%$$

$$Normalized lottery probability in rank 4 : \{ 15 / ( 100 - 30 ) \} \cdot 100 = 21.4 \%$$

$$Normalized lottery probability in rank 5 : \{ 10 / ( 100 - 30 ) \} \cdot 100 = 14.3 \%$$

Accordingly, even when there is a rank in which the number of rated image data is 0, the random printing can be performed in a state in which the ratio of the lottery probability is maintained. Then, the process proceeds to S413 described later.

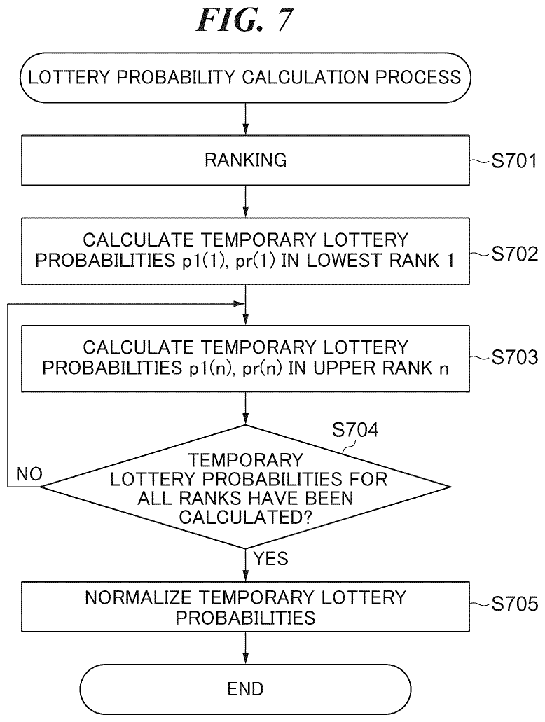

In S412, the controller 101 executes a lottery probability calculation process shown in FIG. 7 described later, and calculates the lottery probabilities. The lottery probabilities calculated in S412 are normalized so that the total of the lottery probabilities set for all the ranks becomes 100%.

Next, in S413, the controller 101 causes the display unit 106 to display a lottery probability setting screen shown in FIG. 6C. This allows the service provider to confirm the lottery probability set for each rank. In addition, the service provider can adjust the lottery probability by setting a preferred lottery probability in a lottery probability setting box 602 on the lottery probability setting screen.

Next, in S414, the controller 101 causes the display unit 106 to display a random print start screen shown in FIG. 6D. This indicates that the preparation for the random printing is completed and the random printing can be started.

Next, in S415, the controller 101 determines whether the start of the random printing has been instructed by a user operation to the operation unit 105. When it is determined that the start of the random printing is not instructed, the process returns to S415. When it is determined that the start of the random printing is instructed, the process proceeds to S416.

In S416, the controller 101 selects the rank of the print target image data based on the set lottery probability. Next, in S417, the controller 101 controls the image selection module 304 to select one image data at random from the image data stored in the folder selected in S405 and having the rank selected in S416. At this time, when the selected image data belongs to a rank equal to or higher than a predetermined value, the controller 101 suggests a special performance. For example, the controller 101 displays a winning screen (special screen) shown in FIG. 6E on the display unit 106 as the special performance. This makes it possible to express a feeling of excitement that image data having a rank equal to or higher than the predetermined value has been selected and to enhance entertainment of a user. The special performance is not limited to this, and a special sound effect may be output, for example.

Next, in S418, the controller 101 controls the print module 307 to print the image data selected in S417 by the printing unit 108. Thereafter, this process is ended.

FIG. 7 is a flowchart illustrating the procedure of the probability calculation process in S412 in FIG. 4. Here, the number of images in a rank n is denoted by Img(n). A one-image lottery probability of one image in the rank n is denoted by P1(n). A rank lottery probability (P1(n)·Img(n)) of the entire rank n is denoted by Pr(n). A temporary one-image lottery probability in the rank n and a temporary rank lottery probability of the entire rank n before normalizing so that the total sum of the probabilities becomes 1 (100%) are respectively denoted by p1(n) and pr(n). A value n of the lowest rank is “1”. A ratio coefficient of a one-image lottery probability and a ratio coefficient of a rank lottery probability are respectively denoted by SL1 and SLr (0≤SL1≤1, 0≤SLr≤1).

As shown in FIG. 7, in S701, the controller 101 controls the lottery probability setting module 303 to rank the image data stored in the folder selected in S405.

Next, in S702, the controller 101 controls the lottery probability setting module 303 to temporarily set a reciprocal of maximum value of the number of images in each rank as a temporary one-image lottery probability p1(1) in the lowest rank 1 (see the following equation (1)). In addition, in S702, the controller 101 controls the lottery probability setting module 303 to multiply p1(1) by the number of images in the lowest rank 1 to calculate a temporary rank lottery probability pr(1) in the entire lowest rank 1 (see the following equation (2)).

$$p 1 ( 1 ) = 1 / Max ( Img ( n ) ) \qquad ( 1 )$$

$$p r ( 1 ) = p 1 ( 1 ) \cdot Img ( 1 ) \qquad ( 2 )$$

Next, in S703, the controller 101 controls the lottery probability setting module 303 to calculate a temporary one-image lottery probability p1(n) in the rank n and a temporary rank lottery probability pr(n) in the entire rank n. Here, the temporary one-image lottery probability p1(n) in the rank n is calculated so as not to exceed the temporary one-image lottery probability p1(n−1) in the rank (n−1) lower by one rank. In addition, the temporary rank lottery probability pr(n) in the entire rank n is calculated so as not to exceed the temporary rank lottery probability pr(n−1) in the entire rank (n−1) lower by one rank. To be more specific, the temporary one-image selection probability p1(n) is set to the smaller one of the probability calculated by dividing the product of the temporary rank selection probability pr(n−1) in the entire lower rank (n−1) and the ratio coefficient SLr by the number of images in the rank n, and the probability obtained by multiplying the temporary one-image lottery probability p1(n−1) in the lower rank (n−1) by the ratio coefficient SL1 (see the following formula (3)). In addition, the temporary rank selection probability pr(n) in the entire rank n is calculated by multiplying the p1(n) by the number of images of the rank n (see the following equation (4)).

$$p 1 ( n ) = IF ( pr ( n - 1 ) \cdot SLr / Im g ( n ) < p 1 ( n - 1 ) \cdot SL 1 , p r ( n - 1 ) \cdot SLr / Img ( n ) , p 1 ( n - 1 ) \cdot SL 1 ) \qquad ( 3 )$$

$$pr ( n ) = p 1 ( n ) \cdot Img ( n ) \qquad ( 4 )$$

Here, the temporary one-image lottery probability p1(n) shall be pr(n−1)·SLr/Img(n) in a case of SL1=0 and shall be p1(n−1)·SL1 in a case of SLr=0. In such a case, the lottery probability setting module 303 can set the temporary one-image lottery probabilities in all ranks to the same probability when SL1=1 and SLr=0, and can set the temporary rank drawing probabilities in all ranks to the same probability when SL1=0 and SLr=1.

Next, in S704, the controller 101 determines whether the temporary lottery probabilities in all the ranks have been calculated. When it is determined that the temporary lottery probability in any rank is not calculated, the process returns to S703. In this way, in the present embodiment, the process in S703 is repeatedly executed until the temporary lottery probabilities in all the ranks are calculated. When it is determined that the temporary lottery probabilities in all the ranks have been calculated, the process proceeds to S705.

In S705, the controller 101 controls the lottery probability setting module 303 to normalize the temporary lottery probabilities in the respective ranks so that the total sum of the lottery probabilities becomes 1 (100%) (see the following formulas (5) and (6)).

$$Rank lottery probability in entire rank n : Pr ( n ) = pr ( n ) / \sum pr ( n ) \qquad ( 5 )$$

$$One - image lottery probability in rank n : P 1 ( n ) = Pr ( n ) / Img ( n ) \qquad ( 6 )$$

As described above, since the temporary lottery probability in the higher rank is calculated from the temporary lottery probability in the lower rank, the lottery probability is calculated by excluding a rank in which the number of target images is 0 (the lottery probability is 0). Thereafter, this process is ended. By the above-described lottery probability calculation process, the lottery probabilities satisfying the following equations (7) and (8) are calculated so that the lottery probability in the higher rank becomes smaller.

$$P 1 ( n ) / P 1 ( n - 1 ) < SL 1 \qquad ( 7 )$$

$$Pr ( n ) / P r ( n - 1 ) < SL r \qquad ( 8 )$$

According to the embodiment described above, the lottery probability is set for each rating information given to the image data. In this manner, it is possible to easily set the lottery probability in the random printing by using the rating information of the image data.

In the above-described embodiment, the number of image data is counted for each rank, and the lottery probability for each rank is calculated based on the counted number of images (count number). Accordingly, for example, the lottery probability of the image data in the lowest rank having the largest number of images is set to be the highest, and the lottery probability of the image data in the highest rank having the smallest number of images is set to be the lowest, so that the entertainment of the random printing can be enhanced.

In the above-described embodiment, the lottery probability for each rank is set based on the lottery probability file. This enables to easy setting of the lottery probability in the random printing while minimizing the load of the process required for calculating the lottery probability.

In the above-described embodiment, the print control apparatus is the printer 100. Accordingly, it is possible to achieve the random printing in which a different lottery probability is set for each rank with a configuration of only the camera and the printer 100 without requiring a PC or the like that instructs to transmit the image data obtained by the lottery from the plurality of image data to the printer 100.

In the above-described embodiment, the storage area is a folder in the storage medium 104 mounted on the printer 100. Accordingly, the random printing in which a different lottery probability is set for each rank can be achieved with a configuration of only the camera and the printer 100 without requiring a server that stores a plurality of image data.

Next, a print control apparatus and a control method thereof according to a second embodiment of the present disclosure will be described.

The second embodiment is basically the same as the first embodiment in terms of the configuration and operation, and is different from the first embodiment in that a synthesized image data, which is obtained by synthesizing image data and decoration data that are respectively selected by lotteries, is printed. Therefore, the descriptions about the same configurations and operations will be omitted, and the different configurations and operations will be described below.

Here, in order to improve the entertainment in the random printing, it is desirable to achieve both of ensuring appropriate rarity by differentiation of the lottery probability according to the rank and setting various synthesis patterns of image data and decoration data. In order to achieve this, in the second embodiment, the lottery of the image data is performed first, the rank of the decoration data to be synthesized is determined based on the rank of the selected image data, and the lottery probability is calculated for the decoration data of the rank.

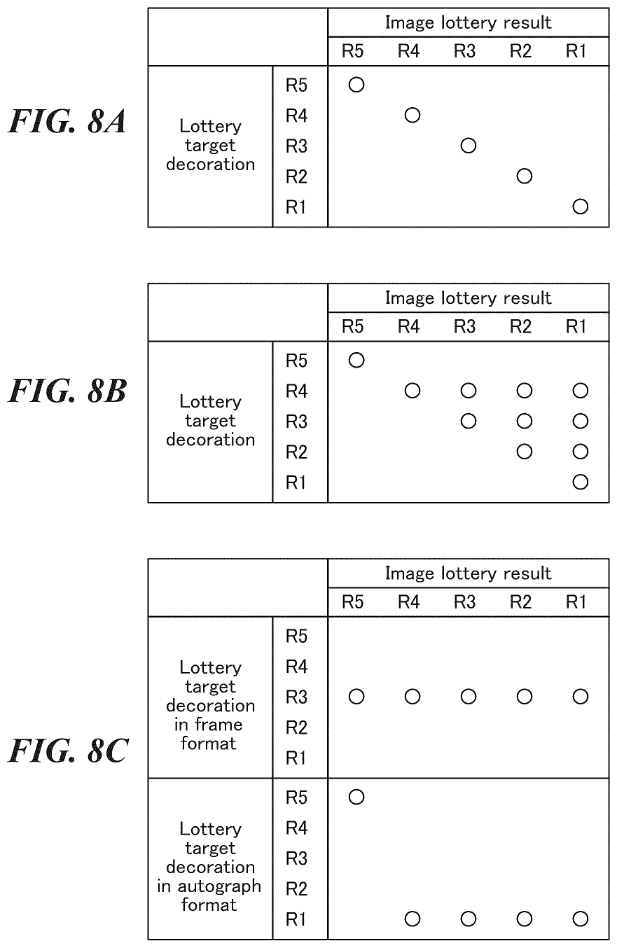

FIG. 8A to FIG. 8C are view showing setting examples of association of decoration data to be synthesized with selected image data. In FIG. 8A to FIG. 8C, “R1” to “R5” mean the rank 1 to the rank 5.

FIG. 8A is a view illustrating an example of a first setting in which decoration data suitable for selected image data is synthesized. In the first setting, the selected image data is synthesized only with decoration data in a rank same as the rank of the selected image data.

FIG. 8B is a view illustrating an example of a second setting that increases synthesis patterns of image data and decoration data while treating decoration data in the highest rank as extremely rare with high rarity. In the second setting, ranks of synthesized decoration data are expanded so as to include a rank of selected image data and higher ranks excluding the highest rank.

As shown in FIG. 5B and FIG. 5C, there are a plurality of types of decoration data, and they can be applied to one image data to be printed. FIG. 8C is a view illustrating an example of a third setting that changes a rank to be synthesized according to a type of decoration data. For example, any one of three decoration data in the frame format in the rank 3 (R3) is always synthesized with image data. On the other hand, the decoration data in the autograph format by the overcoat is additionally synthesized only with image data in the rank 5 (R5). The rank 1 (R1) is a plain overcoat as a protection layer.

In addition, the decoration data may be in a file format different from image data, such as employing a PNG file for a purpose of handling transparent data. When file metadata is edited in a PC environment, environments in which the rating information for a JPG file can be easily changed have been increased, but the file metadata including the rating information for a PNG file cannot be easily edited in many cases. Therefore, in the second embodiment, the rating information may be recorded in the file metadata that differs according to the file format, and the rating information may be extracted and used for calculation of the lottery probability. Accordingly, even when all the file formats of the plurality of image data to be subjected to the lottery of the random printing are not the same, the rating information used for calculating the lottery probability can be extracted from the file metadata corresponding to each file format.

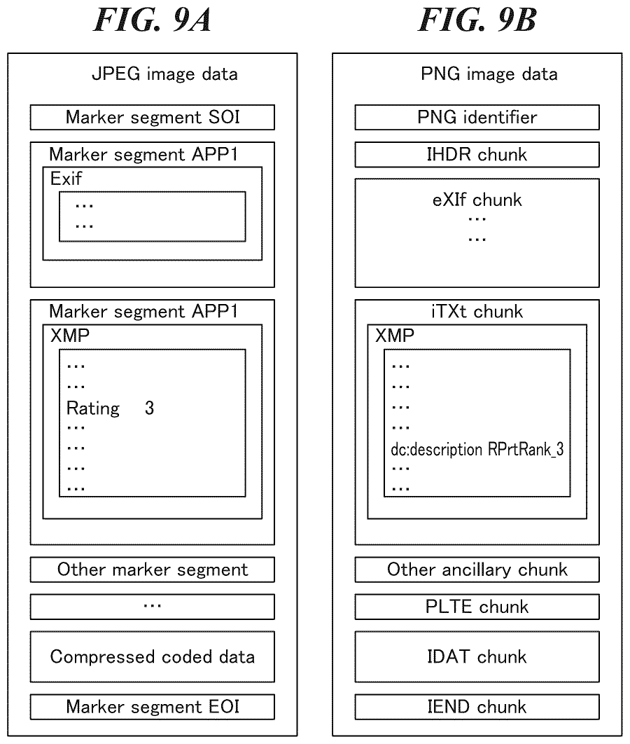

FIG. 9A and FIG. 9B are views illustrating examples of configurations of image data used in the present embodiment. FIG. 9A illustrates an example of a configuration of image data in the JPEG format, and FIG. 9B illustrates an example of a configuration of image data in the PNG format.

In a JPG file, the rank information is recorded in a rating of an XMP. On the other hand, in a PNG file, the rank information is recorded in a predetermined format in a description of the XMP. The file metadata in which the rank information is recorded is not limited to the XMP.

In the second embodiment, a function of limiting a frequency of selections (hereinafter, referred to as a “selection frequency limiting function”) like a lottery can be set. When the setting of the selection frequency limiting function is enable, the information about the image data and the decoration data that are selected and printed is held, and the image data and the decoration data that are selected at a predetermined number of times or more are excluded from the lottery targets (excluded when the number of sheets is counted for each rank) when the lottery probability is calculated in the next and subsequent random printing.

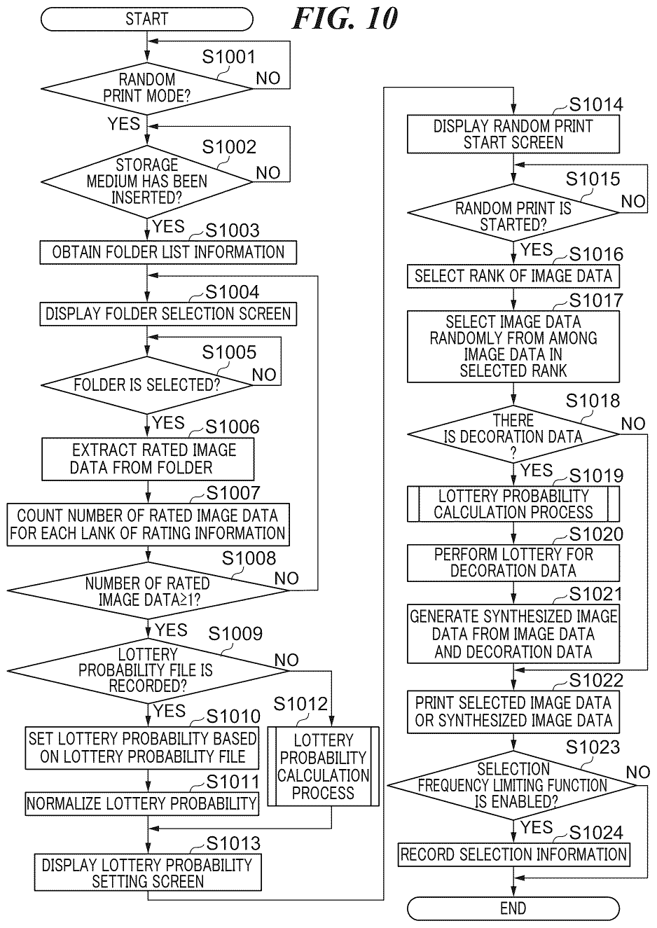

FIG. 10 is a flowchart illustrating a procedure of a random print control process executed by the printer 100 in the second embodiment. The random print control process in FIG. 10 is similar to the random print control process in FIG. 4 described above, and the following description will focus on the differences from the random print control process in FIG. 4 described above. The random printing control process in FIG. 10 is achieved, similarly to the random printing control process in FIG. 4 described above, by the controller 101 controlling each unit of the printer 100 according to an input signal and a program. In addition, the random printing control process in FIG. 10 is also started together with the activation of the printer 100 in response to reception of an instruction to start the random print mode by an activation operation by a user, similarly to the random printing control process in FIG. 4 described above.

In FIG. 10, first, a process in S1001 to S1005, which is the same as the process in S401 to S405 described above, is performed. Here, a folder for selecting image data to be printed shall be selected from the folder group 501, and a folder for selecting decoration data to be printed shall be selected from the folder group 502.

Next, a process in S1006 to S1008, which is the same as the process in S406 to S408 described above, is performed. When a plurality of folders are selected in S1005, the process in S1006 to S1008 is performed for each of the plurality of selected folders.

Next, a process in S1009 to S1012, which is the same as the process in S409 to S412 described above, is performed. Here, when the selection frequency limiting function is enabled, the lottery probability setting module 303 refers to recorded selection information. When the image data corresponding to the selection information is selected at the predetermined number of times or more, the lottery probability setting module 303 excludes the image data from the ranking (S701 in the lottery probability calculation process in S1012). The lottery probability setting module 303 also excludes the image data from the targets of the rank-based number count in S1007 described above, and excludes the image data from the lottery targets.

Next, a process in S1013 to S1017, which is the same as the process in S413 to S417 described above, is performed. Next, in S1018, the controller 101 determines whether there is the decoration data in the rank associated with the rank of the image data selected in S1017 based on the association setting of the decoration data (for example, the settings in FIG. 8A, FIG. 8B, and FIG. 8C described above). When it is determined that there is decoration data in the rank associated with the rank of the image data selected in S1017, the process proceeds to S1019. When it is determined that there is no decoration data in the rank associated with the rank of the image data selected in S1017, the process proceeds to S1022 described later.

In S1019, the controller 101 performs the above-described lottery probability calculation process in FIG. 7, and calculates the lottery probability of the decoration data to be synthesized with the image data selected in S1017 for each type of decoration data. The process in S1019 to calculate the lottery probability of the decoration data is basically the same as that in S1012 to calculate the lottery probability of the image data described above, but a part of the process is different. A different point is, for example, that the rank information is extracted from the file metadata different from the image data when the file format of the decoration data is different from the file format of the image data. In addition, the lottery probability is calculated only for the rank associated with the rank of the selected image data, and the lottery probability is calculated for each type of decoration data. These are also different points.

Next, in S1020, the controller 101 controls the image selection module 304 to perform a lottery for decoration data based on the lottery probability calculated in S1019.

Next, in S1021, the controller 101 controls the image synthesis module 308 to synthesize the image data selected in S1017 and the decoration data selected in S1020 to generate a synthesized image data.

Next, in S1022, the controller 101 controls the print module 307 to perform printing. For example, when it is determined that there is no decoration data in the rank associated with the rank of the selected image data in S1018, the image data selected in S1017 is printed. On the other hand, when it is determined that there is decoration data in the rank associated with the rank of the image data selected in S1018, the synthesized image data generated in S1021 is printed.

Next, in S1023, the controller 101 determines whether the selection frequency limiting function is enabled. When it is determined that the selection frequency limiting function is not enabled, the present process is terminated. When it is determined that the selection frequency limiting function is enabled, the process proceeds to S1024.

In S1024, the controller 101 records the selection information indicating the image data selected in S1017 and the decoration data selected in S1020 in the work memory 103. Thereafter, the present process is terminated.

In the second embodiment described above, the lottery probability of the decoration data is set for each rating information given to the decoration data, and the image data and the decoration data are separately selected by the lottery. This achieves the random printing with an improved entertainment by increasing the number of combination patterns in the print output.

Although the printer 100 is described as an example of the print control apparatus in the above-described embodiments, the print control apparatus is not limited to the printer. For example, the present disclosure is also applicable to a communication apparatus, such as a smartphone, a tablet terminal, or a PC, that controls the printer 100 to print image data.

Although the configuration in which random printing is performed based on the image data stored in the folder in the storage medium 104 has been described in the above-described embodiments, this is not limited. For example, the present disclosure is also applicable to a configuration in which random printing is performed based on image data stored in a cloud server or the like.

According to the present disclosure, a lottery probability in the random printing can be easily set by using rating information of image data.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-215396, filed Dec. 10, 2024 which is hereby incorporated by reference herein in its entirety.

What is claimed is:

1. A print control apparatus capable of controlling to perform random printing to print image data randomly selected from a plurality of image data stored in a storage area, the print control apparatus comprising:
a memory device that stores a set of instructions; and
at least one processor that executes the set of instructions to:
set lottery probabilities of the image data for respective rating information assigned to the image data;
select image data as a print target of the random printing by performing a lottery from among the plurality of image data based on the rating information assigned to the image data and the lottery probabilities set to the image data; and
control a printer to print the image data selected by the lottery.

2. The print control apparatus according to claim 1, wherein the at least one processor executes instructions in the memory device to normalize the lottery probabilities so that a total sum of the lottery probabilities corresponding to the rating information becomes 100%.

3. The print control apparatus according to claim 1, wherein the at least one processor executes instructions in the memory device to:
count the number of the plurality of image data stored in the storage area for the respective rating information;
calculate the lottery probabilities of the image data for the respective rating information based on the number of the image data counted; and
set the lottery probabilities calculated for the respective rating information.

4. The print control apparatus according to claim 1, wherein the at least one processor executes instructions in the memory device to:
obtain a file in which the lottery probabilities for the respective rating information are recorded; and
set the lottery probabilities for the respective rating information based on the file obtained.

5. The print control apparatus according to claim 1, wherein the at least one processor executes instructions in the memory device to enable change of the lottery probabilities by a user.

6. The print control apparatus according to claim 3, wherein the at least one processor executes instructions in the memory device to:
record information about image data selected by the lottery; and
calculate the lottery probabilities based on the number of image data excluding image data that has been selected at a predetermined number of times or more by the lottery.

7. The print control apparatus according to claim 1, wherein the at least one processor executes instructions in the memory device to enable a selection of the storage area by a user.

8. The print control apparatus according to claim 1, wherein the at least one processor executes instructions in the memory device to notify a user to recognize which of a random print mode performing the random printing by the lottery or a normal print mode performing normal printing is set.

9. The print control apparatus according to claim 1, wherein the at least one processor executes instructions in the memory device to suggest a special performance in a case where image data belongs to a rank equal to or higher than a predetermined value is selected by the lottery.

10. The print control apparatus according to claim 9, wherein the special performance is displaying a special screen.

11. The print control apparatus according to claim 9, wherein the special performance is outputting a special sound effect.

12. The print control apparatus according to claim 1, wherein the at least one processor executes instructions in the memory device to:
set lottery probabilities of a plurality of decoration data decorating image data for respective rating information assigned to the decoration data;
select decoration data as a print target of the random printing by performing a lottery from among the plurality of decoration data stored in another storage area than the storage area of the image data based on the rating information assigned to the decoration data and the lottery probabilities set to the decoration data;
generate a synthesized image data by synthesizing the image data selected by the lottery and the decoration data selected by the lottery; and
control the printer to print the synthesized image data.

13. The print control apparatus according to claim 12, wherein the at least one processor executes instructions in the memory device to:
count the number of the plurality of decoration data stored in the other storage area for the respective rating information;
calculate the lottery probabilities of the decoration data based on the counted number of the decoration data and the rating information assigned to the decoration data selected by the lottery; and
set the lottery probabilities of the decoration data calculated for the respective rating information.

14. The print control apparatus according to claim 1, wherein the at least one processor executes instructions in the memory device to extract the rating information recorded in the file metadata assigned to the image data according to the file format.

15. The print control apparatus according to claim 1, further comprising the printer that print the image data selected.

16. The print control apparatus according to claim 1, wherein the storage area is a folder in a storage medium mounted on the print control apparatus.

17. A control method for a print control apparatus capable of controlling to perform random printing to print image data randomly selected from a plurality of image data stored in a storage area, the control method comprising:
setting lottery probabilities of the image data for respective rating information assigned to the image data;
selecting image data as a print target of the random printing by performing a lottery from among the plurality of image data based on the rating information assigned to the image data and the lottery probabilities set to the image data; and
controlling a printer to print the image data selected by the lottery.

18. A non-transitory computer-readable storage medium storing a control program causing a computer to execute a control method for a print control apparatus capable of controlling to perform random printing to print image data randomly selected from a plurality of image data stored in a storage area, the control method comprising:
setting lottery probabilities of the image data for respective rating information assigned to the image data;
selecting image data as a print target of the random printing by performing a lottery from among the plurality of image data based on the rating information assigned to the image data and the lottery probabilities set to the image data; and
controlling a printer to print the image data selected by the lottery.
